(19) United States
(12) Patent Application Publication
(10) Pub. No.: US 2008/0053886 A1
(43) Pub. Date: Mar. 6, 2008

(54) Liquid filter element having keys

(75) Inventors: James N. Marshall, Elm Creek, NE (US); Thomas C. Richmond, Kearney, NE (US); Joshua L. Quackenbush, Kearney, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/516,245

(22) Filed: Sep. 6, 2006

(51) Int. Cl. B01D 35/153

(52) U.S. Cl. 210/234

(57) ABSTRACT

A filter element having a plurality of keys for actuating value or other closure mechanism of a filter is provided. The keys are formed in a radially inner surface of a first end cap. The keys have axially inner and outer free faces as well as a radially inner free face. In one embodiment the keys are integrally formed in an inner annular wall and substantially define a radially inner periphery of the inner annular wall. The keys function to unlock a valve in the filter system.

### FIELD OF THE INVENTION

This invention generally relates to liquid filters and more particularly to liquid filter elements having keys for actuating valves.

### BACKGROUND OF THE INVENTION

Fluid filtration systems for vehicle engines will typically include a filter housing and a filter element. It is common in such fluid filter systems that the filter housing will incorporate a standpipe with a valve on it which when opened permits the flow of fluid through the filtration system. It is also known that when the filter element is removed that the valve will close to thereby prevent impurities from passing downstream and getting into the standpipe during the filter replacement process. While valves on standpipes do provide the aforementioned benefits, some manufacturers have elected to employ tricks for actuating the valve such as shown in U.S. Pat. No. 6,495,042 to Steven R. Knight in which the valve is protected by an additional latch member. This type of arrangement has been commercially employed but unfortunately is disadvantageous to everyone in that it increases the difficulty for maintenance, increases the overall costs of providing the filtration system and has no real benefit to consumers. Nevertheless, due to the existing use of such systems, there are needs for replacement filters for these types of applications. Additionally, there is a need for reliable, cost effective and practical filters for these applications, including components which are easy to manufacture and assemble, to which the present invention is directed.

### BRIEF SUMMARY OF THE INVENTION

The invention provides a filter element that may be used for installation into and use with a filter housing having a standpipe with a closure mechanism to prevent flow therethrough. The filter element comprises a cylindrical ring of filter media extending axially between first and second ends. A first end cap is fixed and sealed to the first end of the ring of filter media. The first end cap includes an inner annular wall extending axially toward the second end and terminates in a free end. A second end cap is fixed and sealed to the second end of the ring of filter media. At least one key, integral with the first annular wall, extends radially inward relative to the first annular wall. The at least one key may be arranged and configured for engaging the closure mechanism. A tubular support member is positioned within the ring of filter media and extends between the end caps. The tubular support member is at least partially permeable to allow for fluid flow therethrough. The tubular support member further includes a seal interface platform disposed between the first and second ends extending radially inward past the free end of the inner annular wall. The seal platform has an inner annular seal of a diameter smaller than the diameter of the inner annular wall.

According to a more detailed embodiment as further described herein, a filter element comprises a cylindrical ring of filter media extending axially between first and second ends. A first end cap is fixed to the first end of the ring of filter media. The first end cap includes a first inner annular wall and a first outer annular wall joined by a first disc portion. The first inner and first outer annular walls extending axially toward the second end and terminate in free ends. The first inner and first outer annular walls and first disc portion form, in combination, a first annular well therebetween. The first annular well has bonding material therein for sealingly bonding the first end of the filter media to the first end cap. A second end cap is fixed to the second end of the ring of filter media. The second end cap includes a second inner annular wall and a second outer annular wall joined by a second disc portion. The second inner and second outer annular walls extend axially toward the first end. The second inner and second outer annular walls and second disc portion form, in combination, a second annular well. The second annular well having bonding material therein sealingly bonding the second end of the filter media to the second end cap. A plurality of keys integral with the first inner annular wall extend radially inward from the first inner annular wall. The plurality of keys include an axially inner free face facing the second end cap, an axial outer free face facing away from the second end cap and a radially inner free face facing radially inward toward a central axis of the filter element. A tubular support member, separate from the first and second end caps, is positioned within the ring of filter media and extends axially substantially the length of the filter media. The tubular support member is partially permeable to allow for fluid flow therethrough. The tubular support member has opposed ends potted in the first and second annular wells between the filter media and the first and second inner annular walls, respectively. The tubular support member further includes a seal interface platform disposed between the first and second ends extending radially inward past the free end of the first inner annular wall. The seal interface platform includes an inner annular seal of a smaller diameter than the first inner annular wall.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional illustration of an exemplary embodiment of a filter element in accordance with the teachings of the present invention;

FIG. 2 is a cross-sectional illustration of the filter element of FIG. 1 partially positioned over a standpipe;

FIG. 3 is a cross-sectional illustration of the filter element of FIG. 2 having the filter element completely installed over the standpipe; and

FIG. 4 is a top view illustration of the valve member of the valve of the stand pipe.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

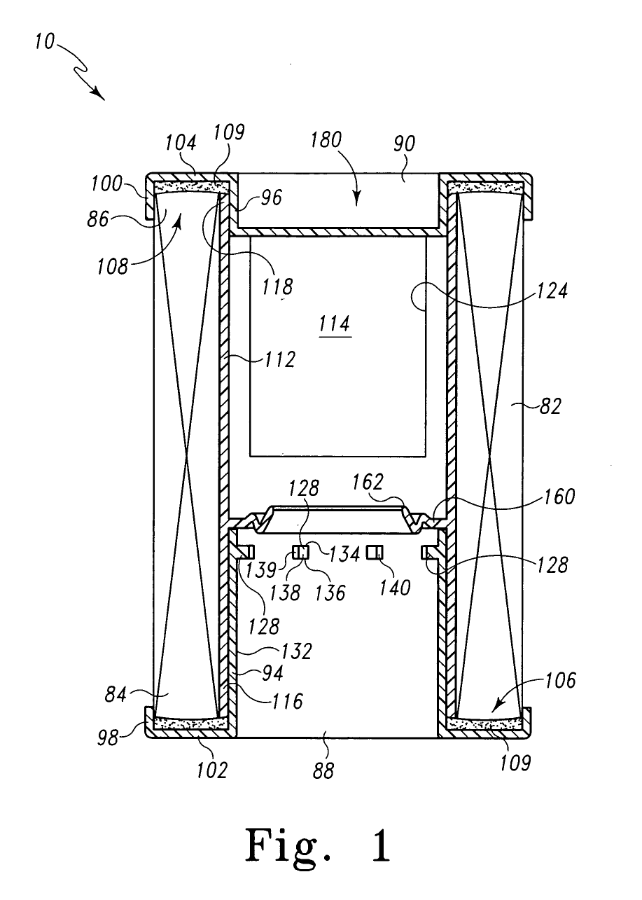

FIG. 1 is a cross-sectional illustration of an embodiment of a liquid filter element 10 in accordance with the teachings of the present invention. The filter element 10 may be configured to filter impurities from fluids such as fuels, lubricants, hydraulic fluids and other like fluids used in or by vehicle engines or machines. The filter element 10 interacts with and actuates a flow closure mechanism, illustrated in the form of valve 44, to permit fluid flow through the system, as will be more fully explained below.

As illustrated in FIG. 3, the filter element 10 mounts to and partially surrounds an axially extending standpipe 30 when it is fully installed. Typically, the standpipe 30 is positioned upright within a filter housing (not shown). The filter element 10 is received in the filter housing and over the standpipe 30. The filter housing surrounds the filter element 10 and forms an unfiltered fluid chamber therebetween. It thus forms a portion of the flow passage for the fluid being filtered, illustrated generally by arrows 122. Particularly, the portion of the fluid 122 upstream from the filter element 10.

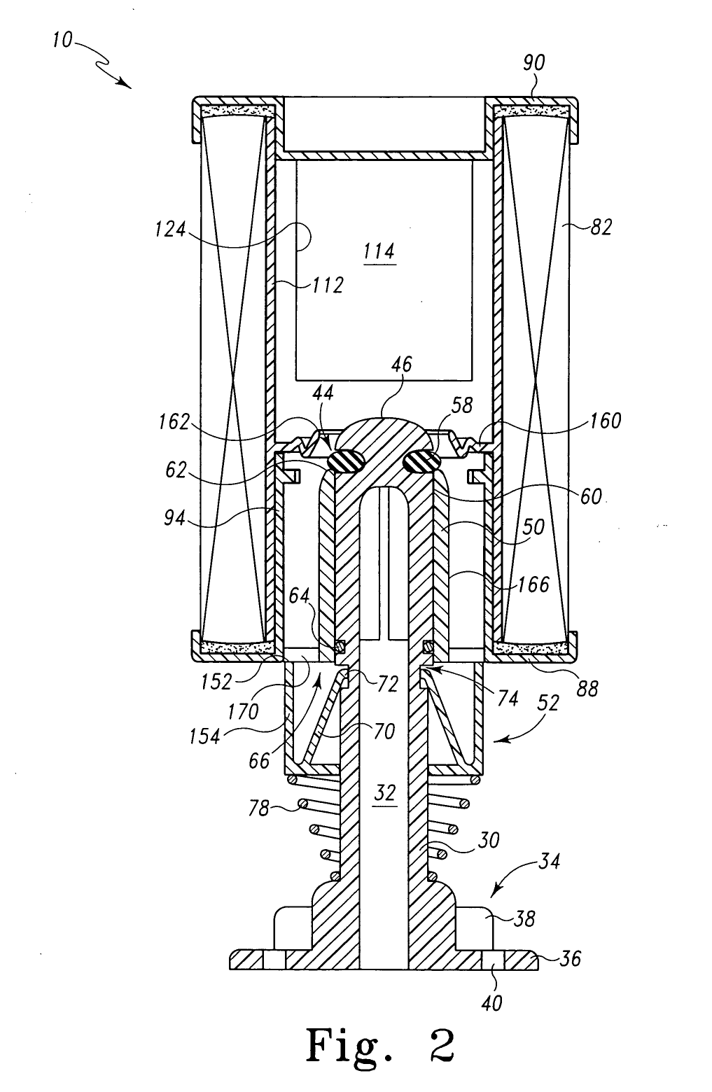

Referring to FIGS. 2 and 3, a central cavity 32 of the standpipe 30 extends substantially the axial length of the standpipe 30 and serves as a clean fluid return passage for the portion of the fluid 122 downstream of the filter element 10. The standpipe 30 includes a base portion 34 for mounting the standpipe 30. The base portion 34 includes a pair of mounting flanges 36 positioned on opposite sides of the central cavity 32. Each mounting flange 36 includes a pair of spaced apart abutment shoulders 38 (only a single abutment shoulder for each flange is illustrated due to the position of the cross-section) and a mounting hole 40. The abutment shoulders 38 act as stops to axially position the filter element 10 relative to the standpipe 30 (see FIG. 3). The mounting holes 40 receive bolts or screws (not shown) for mounting the base portion 34, and consequently, the standpipe 30, to a housing of a fluid using device such as an engine, a fuel pump, an oil pump, and the like (not shown).

The standpipe 30 includes and/or forms a valve 44 that is in an open position (see FIG. 3) or closed position (see FIG. 2) depending on if an appropriate filter element 10 is installed on the standpipe 30. The valve 44 mounts to the standpipe 30 proximate a distal end 46 of the standpipe 30 that is opposite the base portion 34. The valve 44 includes a closure member 50 that circumscribes the standpipe 30 and selectively opens and closes ports 56 through the standpipe. The valve 44 also includes a locking member 52 that selectively engages the standpipe 30 to fix the axial position of the closure member 50. Thus a complex valve 44 is provided using multiple cooperating components.

The closure member 50 is movable between a first position wherein the valve 44 is closed (FIG. 2) and a second position wherein the valve 44 is open (FIG. 3). With reference to FIG. 2, the filter element 10 has not been fully installed on the standpipe 30 and the valve 44 is in the closed position. As such, the closure member 50 is positioned proximate the distal end 46 of the standpipe 30 and overlaps and seals a plurality ports 56 through the sidewall of the standpipe 30 proximate the distal end 46.

The closure member 50 sealingly engages a first o-ring 58 axially positioned between the ports 56 and the distal end 46 of the standpipe 30 forming a first seal between the closure member 50 and the standpipe 30. A free end 62 of the closure member 50 engages the first o-ring 58. An annular groove in the outer surface 60 of the standpipe 30 retains the first o-ring 58. The opposite end 66 of the closure member 50 sealing engages a second o-ring 64 axially positioned between the plurality of openings 56 and the base portion 34 forming a second seal between the closure member 50 and the standpipe 30. The second o-ring 64 seats in a second annular groove in the outer surface 60 of the standpipe 30. In the closed configuration, with the closure member 50 engaging the first and second o-rings 58, 64 on opposite sides of the openings 56, the openings 56 are completely sealed and no fluid may pass there through. As such, the central cavity 32 of the standpipe 30 is not in fluid communication with the filter element 10.

The locking member 52 maintains the axial position of the closure member 50 in the closed position such that the overall valve 44 remains in sealing engagement with the first and second o-rings 58, 64. The locking member 52 generally circumscribes the standpipe 30 and includes a plurality of resilient locking prongs 70 that extend axially toward the distal end 46 of the standpipe 30 and radially inward. The distal ends 72 of the locking prongs 70 engage an annular locking channel 74 formed in the outer surface 60 of the standpipe 30 in the closed position. The engagement between the distal ends 72 and the standpipe 30 prevents the locking member 52 from moving axially along the standpipe 30. Consequently, the closure member 50 is similarly prevented from moving axially along the standpipe 30 toward the base portion 34 when the locking member 52 engages the standpipe 30.

To prevent axial movement along the standpipe 30 in the opposite axial direction, toward distal end 46, the first o-ring 58 is sized to prevent the closure member 50 from sliding past the first o-ring 58. Conversely, to allow the closure member 50 to move axially from the closed position to the open position, the second o-ring 64 is sized sufficiently small that the closure member 50 may slide over the second o-ring 64 when a sufficient axial force is applied thereto, while maintaining a radial seal therebetween. A coil spring 78 positioned between the base portion 34 and the locking member 52 biases the locking member 52 and closure member 50 toward the closed position.

The filter element 10, described with reference to FIG. 1, includes a cylindrical ring of filter media 82 that extends axially between a first end 84 and a second end 86. The filter media 82 may be any practicable filter media for the application but is preferably pleated filter media, and preferably cellulose paper.

Bottom and top end caps 88, 90 are sealingly affixed to the opposing ends 84, 86 of the filter media 82, respectively. The end caps 88, 90 include inner annular walls 94, 96 spaced apart from outer annular walls 98, 100, respectively. The inner and outer annular walls 94, 98 of the bottom end cap 88 are interconnected by a first annular disc portions 102, all of which combine to form an annular well 106. Similarly, the inner and outer annular walls 96, 100 of the top end cap 90 are interconnected by an annular disc portion 104, all of which combine to form an annular well 108. The annular wells 106, 108 receive the opposing ends 84, 86 of the filter media 82, respectively. The annular wells 106, 108 function to hold plastisol 109 or other sealing adhesive to sealingly fix the filter media ends 84, 86 to the end caps 88, 90 by potting, which is generally known to one of ordinary skill in the art. The plastisol 109 seals the filter media ends 84, 86 to the end caps 88, 90 to prevent fluid from short circuiting the filter media 82. Although the filter element 10 is illustrated as having end caps 88, 90 including annular wells 106, 108, for holding plastisol 109, the filter element 10 may be formed without the outer annular wells 98, 100 and corresponding wells 106, 108. In such a configuration, the filter ends 84, 86 of the filter media 82 may be sealingly embedded in an interior side of disc portions 102, 104. For example, plastic material end caps can me melted and the filter media embedded directly into the plastic material of the end caps.

The filter element 10 further includes a tubular support member 112 positioned within the central cavity 114 of the filter media 82. The support member 112 extends the axial length of the filter media 82 from the first end 84 to the second end 86. Furthermore, the support member 112 is positioned radially between the inner periphery of the filter media 82 and the radially outer surface of the inner annular walls 94, 96 (of end caps 88, 90). In the illustrated embodiment, the plastisol 109 in the first annular well 106 sealingly bonds the first end 116 of the tubular support member 112 within the first annular well 106. Similarly, the plastisol 109 in the second annular well 108 sealingly bonds the second end 118 of the tubular support member 112 in the second annular well 108. As illustrated, the tubular support member 112 is formed from molded plastic. However, the tubular support member 112 could be manufactured from other materials.

As fluid must pass through the filter media 82 to be cleaned of impurities, the tubular support member 112 that extends the length of the filter media 82 is permeable to the fluid being filtered. In the illustrated embodiment, the tubular support member 112 includes a plurality of through passages 124 in the form of cutouts in the sidewall of the tubular support member 112. The through passages 124 allow the fluid to pass from the exterior of the filter element 10 the interior 114 of the filter element 10.

As indicate previously, prior to installing a proper filter element onto the standpipe 30 (see FIG. 2), the valve 44 is in a closed position. However, when an appropriate filter element 10 is installed on the standpipe 30, the filter element 10 unlocks the locking member 52 and actuates the closure member 50 such that the valve 44 moves to an open position (see FIG. 3).

To unlock the valve 44, the filter element 10 includes at least one key 128 for axially actuating the locking member 52. In the illustrated embodiment, the filter element 10 includes a plurality of keys 128. The first inner annular wall 94 of the first end cap 88 includes the plurality of keys 128 (however the wall of the unitary support member may alternatively provide the keys). As further illustrated in FIG. 1, the keys 128 extend radially inward toward the longitudinal axis of the filter element 10 from the radially inner surface 132 of the first inner annular wall 94. The keys 128 extend radially inward such that they are free on all sides except for the radially outer side, which is attached to the annular wall 94. As such, the illustrated keys 128 include a free axially inner face 134 facing axially towards the second end cap 90, a free axially outer face 136 facing away from the second end cap 90, a free radially inner face 138 facing radially inward toward the central axis of the filter element, and a pair of opposed free lateral faces 139, 140 (see FIG. 1) that generally face adjacent keys. To readily provide the keys, the end caps can be molded of plastic material.

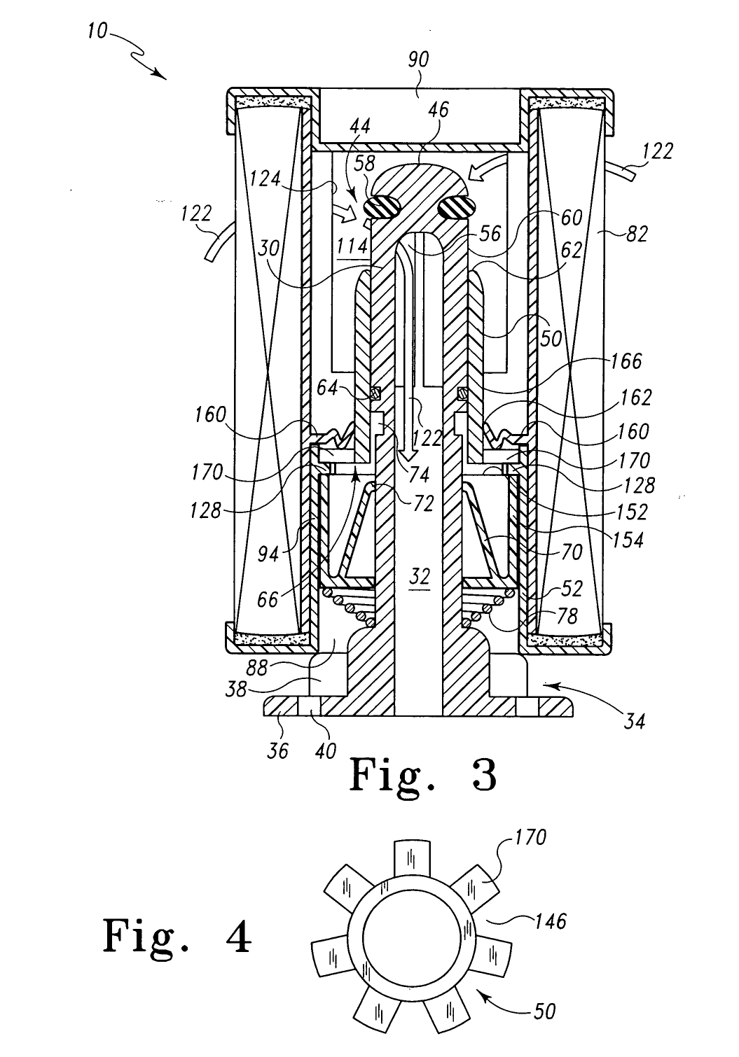

Referring to FIGS. 2-4, as the filter element 10 is installed over the standpipe 30, the keys 128 pass through keyways 146 formed between adjacent radially extending flanges 170 in end 66 of the closure member 50 and engage a free end 152 of an outer annular flange 154 of the locking member 52. As such, as the filter element 10 slides over the standpipe 30, the filter element 10 does not initially actuate the closure member 50 until the locking member 52 is first actuated by contact between the free axially outer face 136 of the keys 128 and the free end 152 of the locking member 52. As the filter element 10 is further axially positioned over the standpipe 30 and moved axially closer to the base portion 34, the filter element 10, acting through the keys 128, actuates the locking member 52 axially towards the base portion 34 causing the locking prongs 70 to resiliently flex such that the distal ends 72 disengage locking channel 74 in the outer surface 60 of the standpipe 30. The distal ends 72 of the locking prongs 70 may include a slightly tapered face to facilitate disengagement from locking channel 74.

The filter element 10, and more particularly the tubular support member 112, includes a radially inward projecting annular sealing platform 160 that includes a resilient sealing lip 162 that provides an aperture. The aperture receives a portion of the standpipe 30 and closure member 50. The sealing lip 162 resiliently engages the outer surface 166 of the closure member 50, as the filter element 10 is inserted onto the standpipe 30 to form a seal. As such, the sealing platform 160, and more particularly the sealing lip 162, extend radially inward beyond the first inner annular wall 94 and its keys 128. This configuration, allows the keys 128 to slide past the closure member 50 while the sealing lip 162 contacts the outer surface 166 of the closure member 50. The sealing platform 160 is positioned axially between the free end of the first inner annular wall 94 and the second end cap 90. The sealing lip 162 may be unitarily formed in the sealing platform 160. To prevent fluid from bypassing the seal, the sealing platform 160 may be a solid or continuous, except for the aperture provided by the sealing lip 162. In an embodiment, the sealing platform 160 abuts with the axial free end of the first inner annular wall 94.

The keys 128 may be evenly annularly spaced apart or pairs of adjacent keys 128 may have varying spacing. The spacing of the keys 128 is coordinated with the spacing required by the closure member 50. Further, the filter element 10 may include one key or multiple keys 128 and no specific number of keys is required.

As illustrated, the sealing lip 162 may be configured to have a radius sized small enough that at some axial position relative to the closure member 50, the sealing lip 162 sufficiently engages the outer surface 166 of the closure member 50 to axially actuate the closure member 50 towards the base portion 34 such that end 62 of the closure member 50 separates from the first o-ring 58 breaking the seal therebetween. As the filter element 10 continues to be installed over the standpipe 30 until the first end cap 88 abuts the abutment shoulders 38 of the base portion 34, the filter element 10 axially actuates the closure member 50 to open the valve 44. As the valve 44 opens, the interior 114 of the filter media 82 becomes fluidly communicated with the interior cavity 32 of the standpipe 30 through ports 56 such that fluid flowing through the filter media 82 may flow from the interior 114 of the filter element 10 and into the standpipe 30.

In an alternative embodiment, and as illustrated in FIGS. 2 and 3, the sealing platform 160 abuts the axially inner surface of the radially extending flanges 170 to axially actuate the closure member 50.

The second end cap 90 includes a recessed portion positioned between and partially defined by the second inner annular wall 96 and extends axially into the central cavity 114 of the filter media 82. A spring (not shown) or portion of the filter housing (not shown) may be received in the recessed portion 180 when the filter element 10 is fully installed in the standpipe 30. The spring or portion of the filter housing can apply an axial load to the filter element 10 to maintain the axial position of the filter element 10 and oppose the opposite axial load being applied by coil spring 78.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element comprising:
a cylindrical ring of pleated filter media extending axially between first and second ends;
a first end cap of plastic material fixed to the first end of the ring of filter media including a first inner annular wall and a first outer annular wall joined by a first disc portion, the first inner and first outer annular walls extending axially toward the second end and terminating in free ends and forming a first annular well therebetween in combination with the first disc portion, the first annular well having bonding material therein sealing bonding the first end of the filter media to the first end cap;
a second end cap of plastic material fixed to the second end of the ring of filter media including a second inner annular wall and a second outer annular wall joined by a second disc portion, the second inner and second outer annular walls extending axially toward the first end forming a second annular well therebetween in combination with the second disc portion, the second annular well having bonding material therein sealing bonding the second end of the filter media to the second end cap;
a plurality of keys integral with the first inner annular wall and extending radially inward from the first inner annular wall, the plurality of keys including an axially inner free face facing the second end cap, an axial outer free face facing away from the second end cap and a radial free face facing radially inward toward a central axis of the filter element; and
a tubular support member positioned within the ring of filter media and extending axially substantially the length of the filter media, the tubular support member being at least partially permeable to allow for fluid flow therethrough, the tubular support member having opposed ends potted in the first and second annular wells between the filter media and the first and second inner annular walls, respectively, the tubular support member further having a seal interface platform disposed between the first and second ends extending radially inward past the free end of the first inner annular wall, the seal interface platform having an inner annular seal of a smaller diameter than the first inner annular wall.

2. The filter element of claim 1, wherein the seal interface platform is positioned axially between the second end cap and the free end of the first inner annular wall.

3. The filter element of claim 2, wherein the inner annular seal is a resilient sealing lip unitarily formed in the seal interface platform and the seal interface platform is solid.

4. The filter element of claim 3, wherein the free end of the first inner annular wall is positioned axially closer to the second end cap than the free end of the first outer annular wall.

5. The filter element of claim 1, wherein the free end of the first inner annular wall is positioned axially inward from the axially inner free face of the keys.

6. A filter element adapted for installation into and use with a filter housing having a standpipe with a closure mechanism to prevent flow therethrough, comprising:
a cylindrical ring of filter media extending axially between first and second ends;
a first end cap sealed to the first end of the ring of filter media, the first end cap including an inner annular wall extending axially toward the second end and terminating in a free end;
a second end cap fixed and sealed to the second end of the ring of filter media;
at least one key integral with the first annular wall and extending radially inward from the first annular wall; and
a tubular support member positioned within the ring of filter media and extending between the end caps, the tubular support member being at least partially permeable to allow for fluid flow therethrough, the tubular support member further having a seal interface platform disposed between the first and second ends extending radially inward past the free end of the inner annular wall, the seal interface platform defining an opening surrounded by an inner annular seal of a diameter smaller than the diameter of the inner annular wall.

7. The filter element of claim 6, wherein the at least one key includes a free inner axially face axially facing the second end, a free outer axial face facing axially away from the second end, and a free inner radial face radially facing a longitudinal central axis of the filter element.

8. The filter element of claim 7, wherein the inner annular seal is formed by a resilient sealing lip unitarily formed into the seal interface platform.

9. The filter element of claim 8, wherein the diameter of the sealing lip is less than the outer diameter of the standpipe, but larger than the outer diameter of the closure mechanism.

10. The filter element of claim 9, wherein the sealing lip engages and actuates a portion of the standpipe when the filter element is mounted thereto and when the at least one keys actuate and engage a locking mechanism of the closure mechanism to position the closure mechanism in an open condition.

11. The filter element of claim 9, wherein the tubular support member engages radially extending flanges of the closure mechanism to actuate the closure mechanism to an open position.

12. The filter element of claim 6, wherein the filter element is substantially metal free having the first and second end caps and tubular support member molded of plastic material.

13. The filter element of claim 6, wherein the seal interface platform is solid except for a central aperture.

14. The filter element of claim 12, wherein the first and second end caps are each unitarily formed bodies and the tubular support member is a unitarily formed body.

15. The filter element of claim 1, wherein the filter media is embedded in the first and second end caps and the tubular support member is embedded into the first and second end caps.
